(19) United States
(12) Patent Application Publication
(10) Pub. No.: US 2026/0034595 A1
(43) Pub. Date: Feb. 5, 2026

(54) DUST SHROUD

(71) Applicant: Home Depot Product Authority, LLC, Atlanta, GA (US)

(72) Inventor: Scott L. Hager, Atlanta, GA (US)

(21) Appl. No.: 19/280,255

(22) Filed: Jul. 25, 2025

Related U.S. Application Data
(60) Provisional application No. 63/677,194, filed on Jul. 30, 2024.

(51) Int. Cl. B23D 59/00

(52) U.S. Cl. CPC B23D 59/0064

(57) ABSTRACT

A dust shroud includes a first member and a second member. The first member and the second member are configured to be securely connected together. When connected together, the first member and the second member form an inlet and an outlet. The inlet includes a flared opening.

### CROSS-REFERENCE TO RELATED APPLICATIONS

This application claims priority to and benefit of U.S. Provisional Application No. 63/677,194, entitled “DUST SHROUD” and filed on Jul. 30, 2024, the entire contents of which are hereby incorporated by reference.

### FIELD

This disclosure relates generally to dust collection. More particularly, this disclosure relates to dust collection shrouds for blind cutting systems.

### BACKGROUND

Window blinds and shades come in a variety of different materials and sizes. The windows upon which the window blinds and shades are being installed also come in a variety of sizes. As a result, window blinds and shades can be cut to a particular length to be customized to fit a corresponding window.

### SUMMARY

In some embodiments, a dust shroud includes a first member and a second member. In some embodiments, the first member and the second member are configured to be securely connected together. In some embodiments, when connected together, the first member and the second member form an inlet and an outlet. In some embodiments, the inlet includes a flared opening.

In some embodiments, the first member and the second member are symmetrical.

In some embodiments, the flared opening includes a first width at the inlet and a second width between the inlet and the outlet. In some embodiments, the second width is smaller than the first width.

In some embodiments, a channel is formed between the inlet and the outlet. In some embodiments, the channel fluidly connects the inlet and the outlet.

In some embodiments, the first member includes a first blade guard, and the second member includes a second blade guard. In some embodiments, when the first member and the second member are connected together, the first blade guard and the second blade guard form an area separated from the channel. In some embodiments, the area is configured to accommodate a cutting blade of a blind cutting machine.

In some embodiments, the area is configured to cover 50% of the cutting blade.

In some embodiments, the outlet is configured to receive a vacuum hose.

In some embodiments, a blind cutting machine includes a frame; a housing supported by the frame; and a cutting assembly disposed within the housing. In some embodiments, the cutting assembly includes a cutting blade and a dust shroud. In some embodiments, the dust shroud includes a first member and a second member. In some embodiments, the first member and the second member are configured to be securely connected together. In some embodiments, when connected together, the first member and the second member form an inlet and an outlet. In some embodiments, the inlet includes a flared opening.

In some embodiments, the first member and the second member are symmetrical.

In some embodiments, the flared opening includes a first width at the inlet and a second width between the inlet and the outlet. In some embodiments, the second width is smaller than the first width.

In some embodiments, a channel is formed between the inlet and the outlet, wherein the channel fluidly connects the inlet and the outlet.

In some embodiments, the first member includes a first blade guard, and the second member includes a second blade guard. In some embodiments, when the first member and the second member are connected together, the first blade guard and the second blade guard form an area separated from the channel. In some embodiments, the area is configured to accommodate the cutting blade.

In some embodiments, the area is configured to cover 50% of the cutting blade.

In some embodiments, the blind cutting machine includes a vacuum. In some embodiments, the outlet is configured to receive a hose of the vacuum.

In some embodiments, a cutting assembly includes a cutting blade and a dust shroud. In some embodiments, the dust shroud includes a first member and a second member.

In some embodiments, the first member and the second member are configured to be securely connected together. In some embodiments, when connected together, the first member and the second member form an inlet and an outlet. In some embodiments, the inlet includes a flared opening.

In some embodiments, the first member and the second member are symmetrical.

In some embodiments, the flared opening includes a first width at the inlet and a second width between the inlet and the outlet. In some embodiments, the second width is smaller than the first width.

In some embodiments, a channel is formed between the inlet and the outlet, wherein the channel fluidly connects the inlet and the outlet.

In some embodiments, the first member includes a first blade guard, and the second member includes a second blade guard. In some embodiments, when the first member and the second member are connected together, the first blade guard and the second blade guard form an area separated from the channel. In some embodiments, the area is configured to accommodate the cutting blade.

In some embodiments, the area is configured to cover 50% of the cutting blade.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a blind cutting machine, according to some embodiments.

FIG. 2 shows a perspective view of a dust shroud for the blind cutting machine of FIG. 1, according to some embodiments.

FIG. 3 shows a first sectional perspective view of the dust shroud of FIG. 2, according to some embodiments.

FIG. 4 shows a second sectional perspective view of the dust shroud of FIG. 2, according to some embodiments.

FIG. 5 shows a bottom perspective view of the dust shroud of FIG. 2, according to some embodiments.

FIG. 6 shows a perspective view of a dust shroud for the blind cutting machine of FIG. 1, according to some embodiments.

Like reference numbers represent the same or similar parts throughout.

### DETAILED DESCRIPTION

Window blinds and shades come in a variety of different materials and sizes. For example, window blinds and shades can include cellular window blinds having a plurality of honeycomb cells, faux wood blinds, or roller shades. The windows upon which the window blinds and shades are being installed also come in a variety of sizes. As a result, window blinds and shades may need to be cut to a particular length to be customized to fit a corresponding window. Embodiments of this disclosure relate to a dust shroud for the cutting assembly of a blind cutting machine that is configured to be located within a retail store so that window blinds and shades can be customized to fit a customer's need within the store. In some embodiments, this can avoid a waiting process in which customer's otherwise order window blinds and shades online and wait for them to be cut and shipped to the customer or a retail store for pickup. More specifically, embodiments of this disclosure relate to improved dust collection features for a blind cutting machine. In some embodiments, the dust shroud can also protect other components of the blind cutting machine by capturing additional dust and debris during the cutting process.

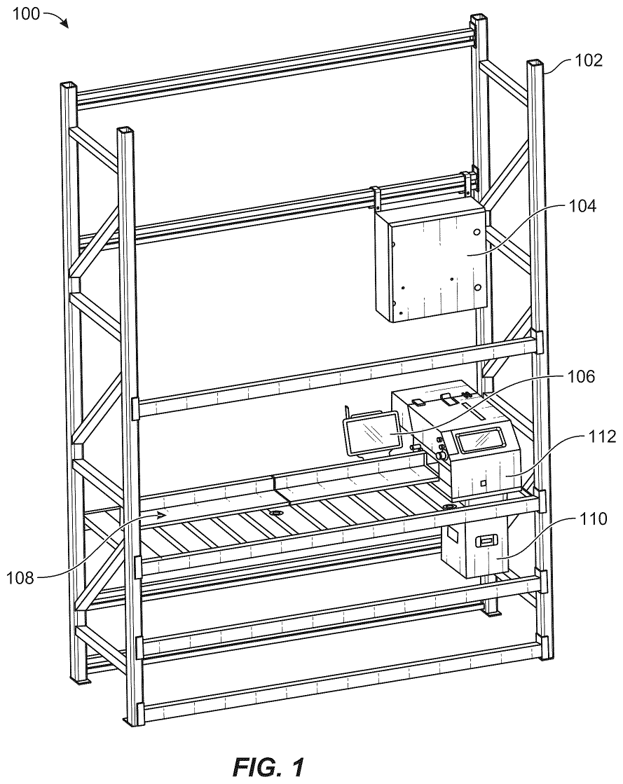

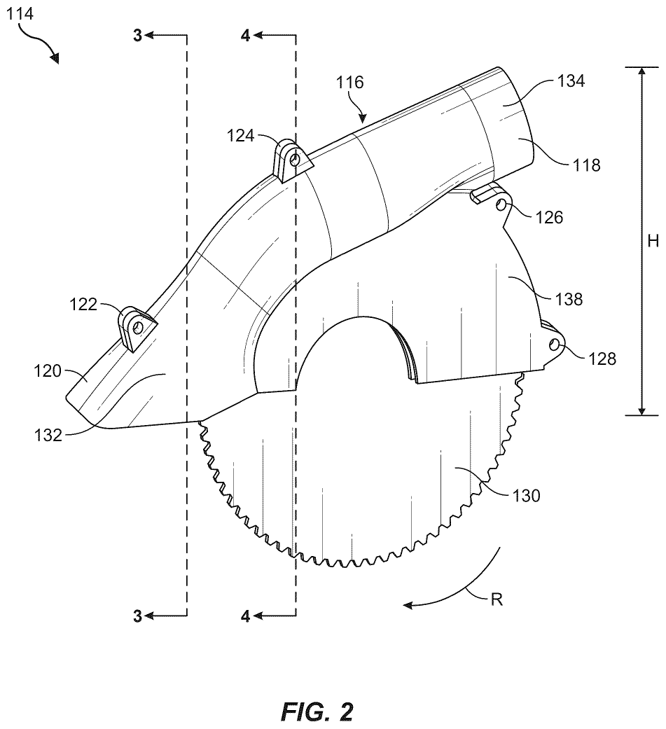

FIG. 1 shows a blind cutting machine 100, according to some embodiments. The blind cutting machine 100 can include a support structure 102. In the illustrated embodiment, the support structure 102 is a frame. It is to be appreciated that the configuration of the support structure 102 can vary beyond the illustrated embodiment. The blind cutting machine 100 includes an electronics module 104, a display screen 106, a platform 108, a cutting assembly 114 (shown in FIG. 2), and a waste bin 110. It is to be appreciated that the blind cutting machine 100 can include one or more additional components.

In some embodiments, the electronics module 104 can include various circuitry to connect the blind cutting machine 100 to a power source.

In some embodiments, the display screen 106 can provide a user interface for an operator to interact with the blind cutting machine 100 and provide for particular settings related to the blind material, length, combinations thereof, or the like.

In some embodiments, the platform 108 can receive a window blind to be cut.

In some embodiments, the cutting assembly can include a housing 112 within which the cutting blade and other components are enclosed, protecting the operator from any interaction with the cutting blade itself. In some embodiments, the cutting assembly can include a dust shroud covering a portion of a cutting blade (see FIGS. 2-5 below). In some embodiments, the dust shroud can be fluidly connected to a dust removal system (e.g., a vacuum or the like).

In some embodiments, the blind cutting machine 100 includes the waste bin 110 for collecting waste from the cutting process.

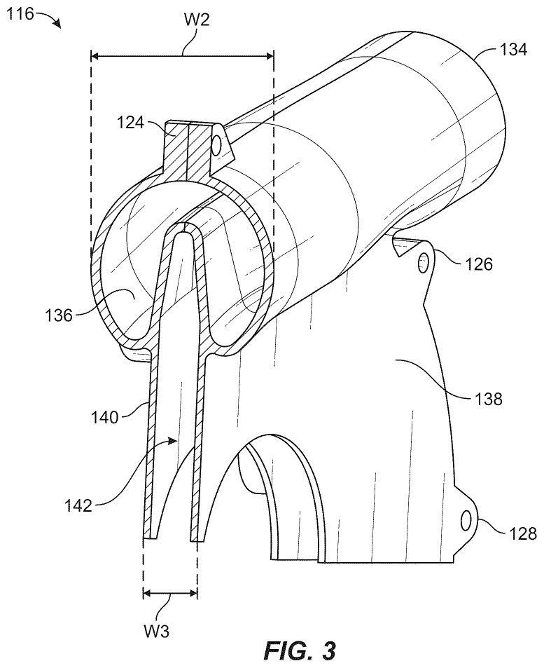

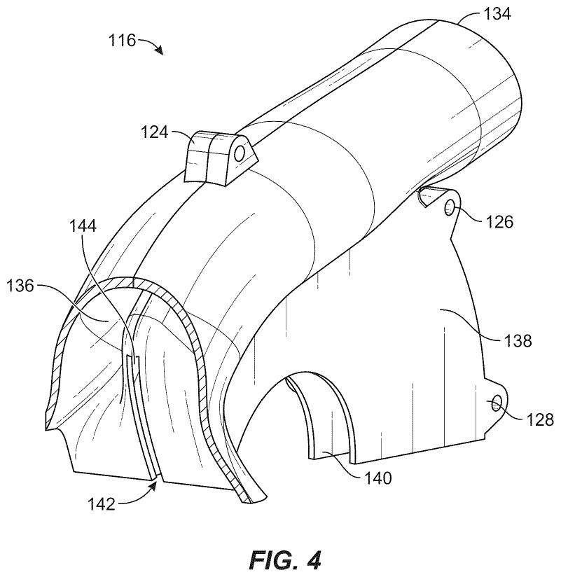

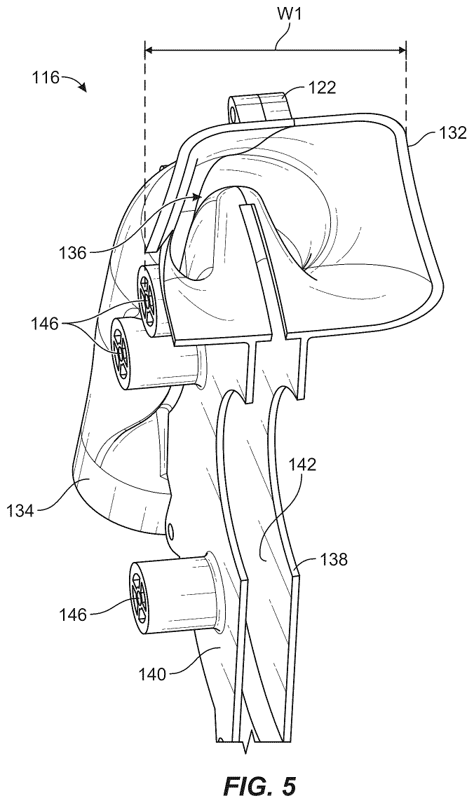

FIG. 2 shows a perspective view of a cutting assembly 114 including a dust shroud 116 for the blind cutting machine 100 of FIG. 1, according to some embodiments. FIG. 3 shows a first sectional perspective view of the dust shroud 116 of FIG. 2, according to some embodiments. FIG. 4 shows a second sectional perspective view of the dust shroud 116 of FIG. 2, according to some embodiments. FIG. 5 shows a bottom perspective view of the dust shroud 116 of FIG. 2, according to some embodiments. FIGS. 2-5 will be described collectively unless specific reference is made otherwise.

The dust shroud 116 includes a first member 118 and a second member 120. The first member 118 and the second member 120 can be secured to each other via one or more fasteners such as, but not limited to, nuts and bolts, at a first aperture 122, a second aperture 124, a third aperture 126, and a fourth aperture 128. It is to be appreciated that the usage of four apertures is an example and that an exact number of apertures for securing the first member 118 and the second member 120 together can vary beyond the stated value. Moreover, the location of the apertures can vary beyond the locations shown in the figures. For example, in some embodiments, less than four apertures may be sufficient for securing the first member 118 and the second member 120. In some embodiments, more than four apertures may be relied upon for securing the first member 118 and the second member 120.

The dust shroud 116 is designed to be symmetrical. That is, in some embodiments, the first member 118 is a mirror image of the second member 120. In some embodiments, the dust shroud 116 can be formed as a single piece then divided by separating in a middle point of the dust shroud 116 to form the first member 118 and the second member 120. In some embodiments, the first member 118 and the second member 120 can be formed separately. In some embodiments, by making the dust shroud 116 two pieces, it is possible to ensure assembly of the dust shroud 116 onto the blind cutting machine 100 (FIG. 1). It is to be appreciated that in some embodiments, the dust shroud 116 can be split into additional pieces. For example, in some embodiments, the first member 118 and the second member 120 can be further split into additional components. In some embodiments, the dust shroud 116 can be formed of a plurality of pieces that are secured together, including more than two pieces.

In some embodiments, the dust shroud 116 can be made of a plastic material. In some embodiments, an overall height H of the dust shroud 116 can be minimized to ensure that the dust shroud 116 fits within the housing 112 (FIG. 1) of the blind cutting machine 100 (FIG. 1). As shown in FIG. 2, the cutting assembly 114 includes a blade 130. The blade 130 is configured to rotate in a direction R. In the illustrated embodiment, the direction R is clockwise. It is to be appreciated that if the blade were to rotate counterclockwise, the dust shroud 116 could be reversed or flipped 180°.

The dust shroud 116 includes an inlet 132 and an outlet 134. A channel 136 is formed within an interior of the first member 118 and the second member 120 when the first member 118 and the second member 120 are joined together. In some embodiments, the inlet 132 can include a brush. In some embodiments, the brush is configured to contact the window blind or shade being cut. In some embodiments, the brush can create an additional barrier so that debris from the cutting process does not escape due to a gap between the dust shroud 116 and the window blind or shade being cut. In some embodiments, the brush can also increase a vacuum suction by reducing an amount of spacing at the inlet 132.

In some embodiments, the inlet 132 includes a flared opening in which an opening of the inlet 132 is larger in size than the channel 136. For example, a width W1 of the outermost extent of the inlet 132 can be greater than a width W2 of the inlet 132 at a location between the inlet 132 and the outlet 134. As a result, the size of the opening at the inlet 132 tapers. In some embodiments, the flared design of the inlet 132 can enable more dust capture when the blade 130 is in use. In some embodiments, as the blade rotates in the direction R, dust and debris is ejected upward toward the inlet 132. By increasing the opening size of the inlet 132, it is possible to catch additional debris. Moreover, tapering the inlet 132 also prevents the channel 136 from being so large that it is difficult to pull the debris from the inlet 132 to the outlet 134. In some embodiments, the channel 136 has an inverted-horse shoe shape. In some embodiments, the flared opening tapering from the inlet 132 to the outlet 134 enables a standard sized vacuum hose to be connected to the outlet 134 while increasing an area at the inlet 132 so that airflow into the dust shroud 116 is maximized while still fitting standardized accessories.

In some embodiments, the dust shroud 116 includes a first blade guard 138 and a second blade guard 140. The first blade guard 138 is formed on the first member 118 and the second blade guard 140 is formed on the second member 120. In some embodiments, the first blade guard 138 and the second blade guard 140 are the same. In some embodiments, the first blade guard 138 and the second blade guard 140 form an area 142 in which the blade 130 is disposed when the dust shroud 116 is installed in the blind cutting machine 100 (FIG. 1). In some embodiments, a width W3 of the area 142 is sufficient to accommodate a width of the blade 130. In some embodiments, the width W3 of the area 142 can be such that clearance is provided on either side of the blade 130. In some embodiments, the width W3 of the area 142 can be selected to be substantially the same as the width of the blade 130 so that when operating, the blade rubs away a portion of the material of the dust shroud 116 and a tight tolerance is maintained between the area 142 and the blade 130. As used herein, substantially the same can be the same subject to manufacturing tolerances or the like. In some embodiments, the width W3 is selected to be bigger so that the blade 130 does not rub away a portion of the material of the dust shroud 116. In some embodiments, any edges of the dust shroud 116 can be rounded to reduce noise from contact between the edges and high pressure, high speed air moving through the system.

In some embodiments, the first blade guard 138 and the second blade guard 140 are designed to surround 50% of the blade 130 with the area 142. In some embodiments, this coverage of the blade 130 with the area 142 can cause additional dust that is not removed via the inlet 132 to fall via gravity toward the waste bin 110 (FIG. 1). In some embodiments, this can reduce an amount of dust that circulates within the housing 112 (FIG. 1). In some embodiments, the amount of coverage can vary beyond 50%. For example, in some embodiments, the coverage can range from 40% to 60%, from 45% to 60%, from 50% to 60%, from 55% to 60%, or subranges within these larger ranges. In some embodiments, the first blade guard 138 and the second blade guard 140 can be formed via an additive manufacturing process such as, but not limited to, a 3D printing process. In such embodiments, complex shapes can cover more than 50% of the cutting blade so long as the blade is exposed to the material intended to be cut. In some embodiments, the 3D printed shape can be in a different number of components than the two described herein, including a single piece or multiple pieces that are joined together in an assembly.

As shown in FIG. 4, the area 142 extends to an extent 144 that is disposed within the inlet 132 region of the dust shroud 116. This placement allows the blade 130 to operate within the channel 136 and provide dust and debris to be collected within the channel 136 and output at the outlet 134.

In some embodiments, the outlet 134 is configured to be connected to a hose of a dust collection system such as, but not limited to, a vacuum. In some embodiments, the vacuum can provide a suction to the dust shroud 116 to increase an amount of dust collected during a cutting operation. In some embodiments, the outlet 134 can be configured to receive a 2.5″ vacuum hose.

As shown in FIG. 5, the dust shroud 116 can include one or more mounting bosses 146. In the illustrated embodiment, three of the one or more mounting bosses 146 are shown. It is to be appreciated that the number can vary beyond three (e.g., less than three or more than three) according to some examples. The one or more mounting bosses 146 can be used to secure the dust shroud 116 in place relative to the blade 130.

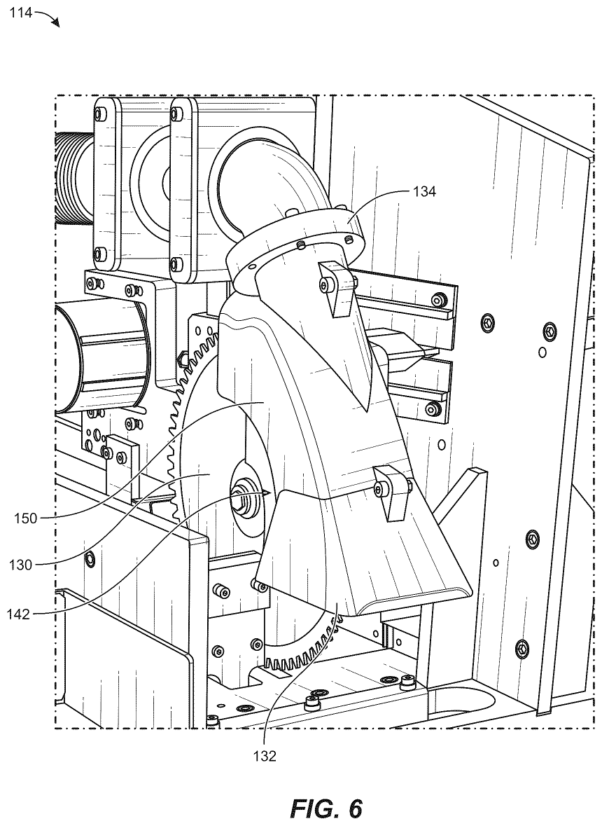

FIG. 6 shows a schematic view of a dust shroud 150, according to some embodiments. Elements of the dust shroud 150 can be the same as or similar to elements of the dust shroud 116 shown and described with reference to FIGS. 2-5 above. For simplicity of this Specification, like features will not be redescribed in additional detail.

In some embodiments, the dust shroud 150 is configured to cover a smaller portion of the blade 130 than the dust shroud 116 (FIGS. 2-5). In some embodiments, the dust shroud 150 are designed to surround 25% of the blade 130 with the area 142. In some embodiments, this coverage of the blade 130 with the area 142 can cause additional dust that is not removed via the inlet 132 to fall via gravity toward the waste bin 110 (FIG. 1). In some embodiments, this can reduce an amount of dust that circulates within the housing 112 (FIG. 1). In some embodiments, the amount of coverage can vary beyond 25%. For example, in some embodiments, the coverage can range from 20% to 40%, from 25% to 40%, from 30% to 40%, from 35% to 40%, or subranges within these larger ranges. In some embodiments, the first blade guard 138 and the second blade guard 140 can be formed via an additive manufacturing process such as, but not limited to, a 3D printing process. In some embodiments, the first blade guard 138 and the second blade guard 140 can be formed using a different process such as, but not limited to, injection molding, bending (e.g., using metal or the like), or the like. In such embodiments, complex shapes can cover more than 25% of the cutting blade so long as the blade is exposed to the material intended to be cut. In some embodiments, the 3D printed shape can be in a different number of components than the two described herein, including a single piece or multiple pieces that are joined together in an assembly.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments,” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

1. A dust shroud comprising:
a first member; and
a second member;
wherein the first member and the second member are configured to be securely connected together;
wherein when connected together, the first member and the second member form an inlet and an outlet;
wherein the inlet includes a flared opening.

2. The dust shroud of claim 1, wherein the first member and the second member are symmetrical.

3. The dust shroud of claim 1, wherein the flared opening comprises a first width at the inlet and a second width between the inlet and the outlet, wherein the second width is smaller than the first width.

4. The dust shroud of claim 1, wherein a channel is formed between the inlet and the outlet, wherein the channel fluidly connects the inlet and the outlet.

5. The dust shroud of claim 4, wherein the first member comprises a first blade guard and the second member comprises a second blade guard, wherein when the first member and the second member are connected together, the first blade guard and the second blade guard form an area separated from the channel, wherein the area is configured to accommodate a cutting blade of a blind cutting machine.

6. The dust shroud of claim 5, wherein the area is configured to cover 50% of the cutting blade.

7. The dust shroud of claim 1, wherein the outlet is configured to receive a vacuum hose.

8. A blind cutting machine comprising:
a frame;
a housing supported by the frame; and
a cutting assembly disposed within the housing,
wherein the cutting assembly comprises:
a cutting blade; and
a dust shroud comprising:
a first member; and
a second member;
wherein the first member and the second member are configured to be securely connected together;
wherein when connected together, the first member and the second member form an inlet and an outlet;
wherein the inlet includes a flared opening.

9. The blind cutting machine of claim 8, wherein the first member and the second member are symmetrical.

10. The blind cutting machine of claim 8, wherein the flared opening comprises a first width at the inlet and a second width between the inlet and the outlet, wherein the second width is smaller than the first width.

11. The blind cutting machine of claim 8, wherein a channel is formed between the inlet and the outlet, wherein the channel fluidly connects the inlet and the outlet.

12. The blind cutting machine of claim 11, wherein the first member comprises a first blade guard and the second member comprises a second blade guard, wherein when the first member and the second member are connected together, the first blade guard and the second blade guard form an area separated from the channel, wherein the area is configured to accommodate the cutting blade.

13. The blind cutting machine of claim 12, wherein the area is configured to cover 50% of the cutting blade.

14. The blind cutting machine of claim 8, further comprising a vacuum, wherein the outlet is configured to receive a hose of the vacuum.

15. A cutting assembly comprising:
a cutting blade; and
a dust shroud comprising:
a first member; and
a second member;
wherein the first member and the second member are configured to be securely connected together;
wherein when connected together, the first member and the second member form an inlet and an outlet;
wherein the inlet includes a flared opening.

16. The cutting assembly of claim 15, wherein the first member and the second member are symmetrical.

17. The cutting assembly of claim 15, wherein the flared opening comprises a first width at the inlet and a second width between the inlet and the outlet, wherein the second width is smaller than the first width.

18. The cutting assembly of claim 15, wherein a channel is formed between the inlet and the outlet, wherein the channel fluidly connects the inlet and the outlet.

19. The cutting assembly of claim 18, wherein the first member comprises a first blade guard and the second member comprises a second blade guard, wherein when the first member and the second member are connected together, the first blade guard and the second blade guard form an arca separated from the channel, wherein the area is configured to accommodate the cutting blade.

20. The cutting assembly of claim 19, wherein the area is configured to cover 50% of the cutting blade.
